(19) United States
(12) Patent Application Publication
(10) Pub. No.: US 2013/0225174 A1
(43) Pub. Date: Aug. 29, 2013

(54) DISTRIBUTED LOAD BALANCING IN CELLULAR WIRELESS NETWORKS

(71) Applicant: Rajagura Mudiyanselage Mythri Hunukumbure, Hillingdon (GB)

(72) Inventor: Rajagura Mudiyanselage Mythri Hunukumbure, Hillingdon (GB)

(73) Assignee: FUJITSU LIMITED, Kawasaki-shi, Kanagawa (JP)

(21) Appl. No.: 13/814,166

(22) PCT Filed: Aug. 4, 2010
(86) PCT No.: PCT/EP2010/061368

§ 371 Date: May 13, 2013

(51) Int. Cl. H04W 36/22

(52) U.S. Cl. CPC H04W 36/22
USPC 455/436

(57) ABSTRACT

A distributed load balancing method for use in a cell of a cellular wireless network, in which a first parameter of each cell participating in the method is indicative of the operational performance of the cell and has an optimum value, and in which a second parameter of each cell participating in the method is indicative of the degree of acceptance by the cell of user transfers to the cell relative to the degree of requests by the cell to transfer users from the cell and has an optimum value.

The present invention relates to distributed load balancing in cellular wireless networks, in particular, but not exclusively, 3GPP LTE-A networks.

Load balancing is an essential feature of a cellular network, especially when the network load has dynamic variations. With its flat architecture and the x2 interface for inter-eNodeB communications, the LTE (Long Term Evolution) framework provides an opportunity to implement more distributed load balancing algorithms, where the eNodeBs (serving cells or base stations) have greater control on deciding their behaviour. Current discussions on load balancing within the LTE standards are focused on distributed algorithms where neighbouring eNodeBs decide on load balancing behaviour through handovers, without the participation of centralized control apparatus of the network, such as the operations and maintenance centre (OAM). However, as the load balancing requirement may indicate wider network performance issues, it is desirable that the centralized control apparatus is updated on these issues.

According to an embodiment of a first aspect of the present invention there is provided a distributed load balancing method for use in a cell of a cellular wireless network, in which a first parameter of each cell participating in the method is indicative of the operational performance of the cell and has an optimum value and in which a second parameter of each cell participating in the method is indicative of the degree of acceptance by the cell of user transfers to the cell relative to the degree of requests by the cell to transfer users from the cell and has an optimum value, which method comprises a first cell carrying out the steps of: determining, in response to the first cell receiving a request to provide service for specified users in a second cell of the cellular wireless network which neighbours the first cell, whether to provide service for the specified users of the second cell by evaluating whether, on the basis of its current load, a value of the first parameter will be adversely affected if the request of the second cell is accepted and users are transferred from the second cell to the first cell; accepting or declining the request of the second cell in accordance with the result of the determining step; updating the value of the second parameter to reflect the result of the determining step; and advising cells neighbouring the first cell and a control means of the network, common to a plurality of cells in the network including the first cell, of the updated value of the second parameter.

If it is determined that the value of the said first parameter will be adversely affected, preferably a secondary request is sent to cells neighbouring the first cell, which are not neighbours of the second cell, to provide service for specified users of the first cell, and, if the secondary request of the first cell is accepted, the request of the second cell is accepted, the specified users are transferred from the first cell and the second cell, the value of the second parameter of each cell which accepted the secondary request is updated to reflect the acceptance, and cells neighbouring each cell which accepted the secondary request and the control means are advised of that updated value.

Still more preferably, a further secondary request is issued by each of n further cells in the network, a further secondary request issued by the nth cell being a request for another cell to provide service for specified users of the nth cell, where 1≦n≦N, N is a preset maximum number of cells which are permitted to issue such a further secondary request, and the nth cell is neighboured by the (n−1)th cell, except where n is 1 where it is neighboured by the first cell, a further secondary request being issued by the nth cell when, on the basis of the current load of the nth cell, the value of the first parameter of the nth cell will be adversely affected by accepting a further secondary request from the (n−1)th cell, except when n is 1 in which case a further secondary request is issued by the nth cell when, on the basis of the current load of the nth cell, the value of the first parameter of the nth cell will be adversely affected by accepting the secondary request of the first cell, wherein, if the further secondary request of the nth cell is accepted: the received request of the (n−1)th cell is accepted and the specified users are transferred from the (n−1)th cell and the nth cell, except where n is 1 in which case the received request of the first cell is accepted and the specified users are transferred from the first cell and the nth cell; the value of the second parameter of the (n+1)th cell, which accepted the secondary request, is updated to reflect the acceptance; and cells neighbouring the (n+1)th cell and the control means are advised of that updated second parameter value.

The value of the first parameter of a cell which accepts a request to provide service for specified users of another cell may be updated and the control means may be advised of that updated value of the first parameter.

According to an embodiment of a second aspect of the present invention there is provided a distributed load balancing method for use in cells of a cellular wireless network in which method a first secondary request for another cell to provide service for specified users of a first cell is issued when the first cell, which has received a primary request issued by a second cell of the network for another cell in the network to provide service for specified users of the second cell, is unable, on the basis of its current load, to accept the primary request without adversely affecting its operational performance, wherein a further secondary request is issued by each of n further cells in the network, a further secondary request issued by the nth cell being a request for another cell to provide service for specified users of the nth cell, where 1≦n≦N, N is a preset maximum number of cells which are permitted to issue such a further secondary request, and the nth cell is neighboured by the (n−1)th cell, except where n is 1 where it is neighboured by the first cell, a further secondary request being issued by the nth cell when the operational performance of the nth cell will be adversely affected by accepting a further secondary request from the (n−1)th cell, except when n is 1 in which case a further secondary request is issued by the nth cell when the operational performance of the nth cell will be adversely affected by accepting the secondary request of the first cell, and, if the further secondary request of the nth cell is accepted, the received request of the (n−1)th cell is accepted and the specified users are transferred from the (n−1)th cell and the nth cell, except where n is 1 in which case the received request of the first cell is accepted and the specified users are transferred from the first cell and the nth cell.

For the first cell, whether or not the operational performance of the first cell is deemed to be adversely affected by a decision to accept the secondary request of the second cell may be determined by considering the affect of that decision on a first parameter of the first cell, which first parameter is indicative of the operational performance of the first cell and has an optimum value.

The value of the first parameter of the first cell may be updated when a request to provide service for specified users of the second cell has been accepted and control means of the network, common to a plurality of cells in the network including the first cell, may be advised of that updated value of the first parameter.

The value of a second parameter of the first cell, which is indicative of the degree of acceptance by the first cell of user transfers to the cell relative to the degree of requests by the cell to transfer users from the cell and has an optimum value, may be updated on the basis of whether or not the request of the second cell has been accepted and cells neighbouring the first cell and the control means of the network may be advised of the updated value of the second parameter.

In embodiments of either the first or second aspects of the present invention, if the secondary request of a cell is not accepted, whether to accept the request received by that cell may be determined by calculating what changes in the values of the said first and second parameters of that cell would be caused by accepting the received request, and the decision to accept or decline the received request may be made on the basis of a comparison using the changed values for the first and second parameters of that cell. In order to make the decision to accept or decline the received request on the basis of the comparison, the proximity of the changed value of the second parameter to a preselected value for the second parameter and the proximity of the changed value of the first parameter to a preselected value for the first parameter are determined. The preselected value for the second parameter may be changed in response to a second parameter preselected value adjustment request from the control means.

In embodiments of either the first or second aspects of the present invention, the optimum value for the second parameter may be changed in response to a second parameter optimum value adjustment request from the control means.

In embodiments of either the first or second aspects of the present invention, when determining whether to provide service for the specified users of a cell, account may be taken of the current value of the second parameter of that cell.

In embodiments of either the first or second aspects of the present invention, when determining whether to provide service for the specified users of a cell, account may be taken of the current value of the second parameter of that cell.

In embodiments of either the first or second aspects of the present invention, the amount of change in the value of the second parameter made when a request is accepted by a cell may be dependent upon the value of the second parameter of the cell which made the request before acceptance of the request.

In embodiments of either the first or second aspects of the present invention, the value of the second parameter of a cell in the network may be downgraded when it issues a request for another cell to provide service for specified users in the cell, except where this request is in response to a request of a further cell to provide service for users in the said further cell.

In embodiments of either the first or second aspects of the present invention, the manner in which the value of the second parameter is updated may be changed for a particular result in accordance with a request issued by the control apparatus.

In embodiments of either the first or second aspects of the present invention, in order to evaluate whether the value of the first parameter will be adversely affected, the change in the value of the first parameter which would be caused by accepting the received request may be calculated, the changed value may be compared with a preselected value for the first parameter, and it may be determined that the value of the first parameter will be adversely affected if the changed value is less than the preselected value, when the optimum value for the first parameter is higher than the preselected value, or if the changed value is more than the preselected value, when the optimum value for the first parameter is lower than the preselected value.

In embodiments of either the first or second aspects of the present invention, the optimum value for the first parameter may be changed in response to an first parameter optimum value adjustment request from the control means.

In embodiments of either the first or second aspects of the present invention, the preselected value for the first parameter may be changed in response to a first parameter preselected value adjustment request from the control means.

According to an embodiment of a third aspect of the present invention there is provided apparatus for use in a first cell of a cellular wireless network, in which network a first parameter of a cell is indicative of the operational performance of the cell and has an optimum value and in which network a second parameter of a cell is indicative of the degree of acceptance by the cell of user transfers to the cell relative to the degree of requests by the cell to transfer users from the cell and has an optimum value, which apparatus comprises: request receiving means configured to receive, from a second cell of the cellular wireless network which neighbours the first cell, a request to provide service for specified users in the second cell; determining means configured to determine whether to provide service for the specified users of the second cell, which determining means are operable to evaluate whether, on the basis of its current load, a value of the first parameter will be adversely affected if the request of the second cell is accepted and users are transferred from the second cell to the first cell; response means configured to accept or decline the request of the second cell in accordance with the result of the determining means; updating means configured to update the value of the second parameter to reflect the result of the determining means; and advising means configured to advise cells neighbouring the first cell and a control means of the network, common to a plurality of cells in the network including the first cell, of the updated value of the second parameter.

Preferably, if the determining means determine that the value of the said first parameter will be adversely affected, the determining means are operable to initiate the transmittal to cells neighbouring the first cell, which are not neighbours of the second cell, of a secondary request to provide service for specified users of the first cell, to agree to the request of the second cell if the secondary request of the first cell is accepted and the specified users are transferred from the first cell, to update the value of the second parameter of each cell which accepted the secondary request to reflect the acceptance, and to advise cells neighbouring each cell which accepted the secondary request and the control means of that updated value.

The updating means may be configured to update the value of the first parameter of a cell which accepts a request to provide service for specified users of another cell and the advising means may be configured to advise the control means of that updated value of the first parameter.

Desirably, if the secondary request of a cell is not accepted, the determining means are operable to determine whether to accept the request received by that cell by calculating what changes in the values of the said first and second parameters would be caused by accepting the received request, and making the decision to accept or decline the received request on the basis of a comparison using the changed values for the first and second parameters. In order to make the decision to accept or decline the received request on the basis of the comparison, the determining means may be operable to determine the proximity of the changed value of the second parameter to a preselected value for the second parameter and to determine the proximity of the changed value of the first parameter to a preselected value for the first parameter.

The apparatus may comprise preselected value changing means configured to change the preselected value for the second parameter in response to a second parameter preselected value adjustment request from the control means.

Apparatus embodying the third aspect of the present invention may further comprise optimum value changing means configured to change the optimum value for the second parameter in response to a second parameter optimum value adjustment request from the control means.

When determining whether to provide service for the specified users of the cell which issued the secondary request, the determining means may be operable to take account of the current value of the second parameter of that cell and/or the cell receiving the request.

The updating means may be configured to change the manner in which the value of the second parameter is updated for a particular result in accordance with a request issued by the control apparatus.

In order to evaluate whether the value of the first parameter will be adversely affected, the determining means may be operable to calculate the change in the value of the first parameter which would be caused by accepting the received request, compare the changed value with a preselected value for the first parameter, and determine that the value of the first parameter will be adversely affected if the changed value is less than the preselected value, if the optimum value for the first parameter is higher than the preselected value, or if the changed value is more than the preselected value, if the optimum value for the first parameter is lower than the preselected value. The apparatus may further comprise preselected value changing means configured to change the preselected value for the first parameter in response to a first parameter preselected value adjustment request from the control means.

The apparatus may further comprise optimum value changing means configured to change the optimum value for the first parameter in response to an first parameter optimum value adjustment request from the control means.

According to an embodiment of a fourth aspect of the present invention there is provided a method of controlling apparatus used in a cellular wireless network, in which network a first parameter of a cell is indicative of the operational performance of the cell and has an optimum value and in which network a second parameter of a cell is indicative of the degree of acceptance by the cell of user transfers to the cell relative to the degree of requests by the cell to transfer users from the cell and has an optimum value, which method comprises: monitoring the values of the first and second parameters of cells in the cellular wireless network; and adjusting the amount of change in the value of the second parameter, which is to be imposed upon updating of the second parameter, of a designated one of the cells on the basis of one or more of the monitored values in accordance with an objective to be achieved.

A method embodying the fourth aspect of the present invention may further comprise adjusting the optimum value for the first parameter and/or the optimum value for the second parameter of a designated one of the cells in accordance with an objective to be achieved.

A method embodying the fourth aspect of the present invention may further comprise adjusting a preselected value for the first parameter and/or a preselected value for the second parameter of a designated one of the cells in accordance with an objective to be achieved, which preselected values are used by the cell in determining whether to accept a request to transfer users to the cell.

In a method embodying the fourth aspect of the present invention, similar or related past events are taken into account when an adjustment is made.

According to an embodiment of a fifth aspect of the present invention there is provided control apparatus for use in a cellular wireless network, in which network a first parameter of a cell is indicative of the operational performance of the cell and has an optimum value and in which network a second parameter of a cell is indicative of the degree of acceptance by the cell of user transfers to the cell relative to the degree of requests by the cell to transfer users from the cell and has an optimum value, which apparatus comprises: monitoring means configured to monitor the values of the first and second parameters of cells in the cellular wireless network; and adjustment means configured to adjust the amount of change in the value of the second parameter, which is to be imposed upon updating of the second parameter, of a designated one of the cells on the basis of one or more of the monitored values in accordance with an objective to be achieved.

The adjustment means may also be configured to adjust the optimum value for the first parameter and/or the optimum value for the second parameter of a designated one of the cells in accordance with an objective to be achieved.

The adjustment means may also be configured to adjust a preselected value for the first parameter and/or a preselected value for the second parameter of a designated one of the cells in accordance with an objective to be achieved, which preselected values are used by the cell in determining whether to accept a request to transfer users to the cell.

The configuration of the adjustment means may be such that similar or related past events are taken into account when an adjustment is made.

According to an embodiment of a sixth aspect of the present invention there is provided a cellular wireless network comprising a plurality of cells which neighbour one another, in which cells a first parameter of a cell is indicative of the operational performance of the cell and has an optimum value and in which cells a second parameter of a cell is indicative of the degree of acceptance by the cell of user transfers to the cell relative to the degree of requests by the cell to transfer users from the cell and has an optimum value, wherein each of the neighbouring cells is provided with apparatus embodying the third aspect of the present invention.

The network may be configured such that each of n cells in the network is configured to issue a further secondary request, a further secondary request issued by the nth cell being a request for another cell to provide service for specified users of the nth cell, where 1≦n≦N, N is a preset maximum number of cells which are permitted to issue such a further secondary request, and the nth cell is neighboured by the (n−1)th cell, except where n is 1 where it is neighboured by the first cell, the nth cell being operable to issue a further secondary request when, on the basis of the current load of the nth cell, the value of the first parameter of the nth cell will be adversely affected by accepting a further secondary request from the (n−1)th cell, except when n is 1 in which case the nth cell is operable to issue a further secondary request when, on the basis of the current load of the nth cell, the value of the first parameter of the nth cell will be adversely affected by accepting the secondary request of the first cell, wherein, if the further secondary request of the nth cell is accepted: the nth cell is operable to accept the received request of the (n−1)th cell, to receive the specified users from the (n−1)th cell and to transfer its specified users to an (n+1)th cell, except where n is 1 in which case the received request of the first cell is accepted and the specified users are transferred from the first cell and the nth cell; and the (n+1)th cell, which accepted the secondary request, is operable to update the value of its second parameter to reflect the acceptance and to advise cells neighbouring the (n+1)th cell and the control means of that updated second parameter value.

According to an embodiment of a seventh aspect of the present invention there is provided a cellular wireless network comprising a plurality of cells, which network is configured to respond to a first secondary request for another cell of the network to provide service for specified users of a first cell of the network, which secondary request has been issued when the first cell is unable, on the basis of its current load, to accept a primary request, issued by a second cell of the network for another cell in the network to provide service for specified users of the second cell, without adversely affecting its operational performance, by causing a chain of n further cells of the network to issue further secondary requests, a further secondary request issued by the nth cell in the chain being a request for another cell to provide service for specified users of the nth cell, where 15≦n≦N, N is a preset maximum number of cells which are permitted to issue such a further secondary request, and the nth cell is neighboured by the (n−1)th cell, except where n is 1 where it is neighboured by the first cell, wherein each of the n cells is provided with apparatus comprising determining means configured to determine whether the cell should accept a further secondary request from the preceding cell in the chain by evaluating, on the basis of its current load, whether the operational performance of the cell will be adversely affected by accepting the further secondary request and, if so, to initiate transmittal of a further secondary request, and response means operable, if the further secondary request of the cell is accepted, to accept the further secondary request from the preceding cell in the chain and cause the specified users to be transferred from the cell and the preceding cell.

In a network embodying the seventh aspect of the present invention, the determining means of the first cell may be operable to determine whether or not the operational performance of the first cell is deemed to be adversely affected by a decision to accept the secondary request of the second cell by considering the affect of that decision on a first parameter of the first cell, which first parameter is indicative of the operational performance of the first cell and has an optimum value. Such a network may further comprise first updating means for updating the value of the first parameter of the first cell when a request to provide service for specified users of the second cell has been accepted and advising means for advising control means of the network, common to a plurality of cells in the network including the first cell, of that updated value of the first parameter.

In a network embodying the seventh aspect of the present invention, second updating means may be provided for updating the value of a second parameter of the first cell, which is indicative of the degree of acceptance by the first cell of user transfers to the cell relative to the degree of requests by the cell to transfer users from the cell and has an optimum value, on the basis of whether or not the request of the second cell has been accepted, the advising means being operable to advise cells neighbouring the first cell and the control means of the network of the updated value of the second parameter.

A cellular wireless network embodying the sixth or seventh aspect of the present invention may further comprise control apparatus embodying the fifth aspect of the present invention.

According to an embodiment of an eighth aspect of the present invention there is provided a computer program which, when executed on a computer, causes that computer to become apparatus embodying the third or fifth aspects of the present invention, or part of a network embodying the sixth or seventh aspects of the present invention, or causes that computer to carry out a method embodying the first, second of fourth aspects of the present invention.

Distributed load balancing in wireless networks is known, for example, from US2009040989 A1 and US2009274129 A1. US2009040989 A1 describes different network topologies which can compromise between extreme delay and extreme throughput to provide the desired performance. Different network topologies are compared to the ‘star’ network formation. The nodes have a mesh connectivity so they can route the load avoiding congested nodes. Load balancing comes from this situation-aware behaviour. In contrast, embodiments of the present invention relate to a cellular wireless network topology where the nodes have limited options to transfer their excessive load and also limited knowledge of the other nodes' dynamic load conditions, and communication amongst neighbouring nodes is employed for load balancing.

US2009274129 A1 discusses methods for switching clients (users) away from the currently serving node to other potential nodes for the purpose of load balancing. The switch is initiated by the client and the nodes provide the parameters to enable switching. These parameters include reducing the received power from the current serving node through transmit power reduction, beam-forming, antenna pattern changing etc. The same methods can be used to increase the received power from neighbour nodes to facilitate switching. In contrast, in embodiments of the present invention, the nodes initiate the switching of users for load balancing and decision making by the neighbouring nodes on accepting the additional load is employed.

As compared to a centralized load-balancing mechanism, embodiments of the present invention reduce the need for a highly-available, process-intensive load balancing unit at the control apparatus. In addition, the possibility of a ‘single point of failure’, associated with a centralized control apparatus-based algorithm, can be avoided.

According to an embodiment of the present invention, centralized control apparatus of the network, such as the OAM, monitors values of the first and second parameters of the cells (eNodeBs) and influences the cell (eNodeB) behaviour. Thus, as compared with current specifications in LTE for distributed load balancing, centralized control apparatus (for example the OAM) embodying the present invention can observe the behaviour of the network, detect developing problems such as under-serving of a capacity hotspot (i.e. an area where communication traffic is relatively high) and take remedial action through changing scoring strategies. If required, such issues can also be reported to a higher level part of the network for long term solutions.

Current LTE specifications allow load balancing only between two neighbouring cells. In an embodiment of the present invention, however, if an eNodeB cannot accommodate a load balancing request received from a neighbouring eNodeB, it can issue its own request to offload some of its active users and, if this is successful, it can accept the original request. This feature helps to balance the load over a wider region than the two neighbouring cells currently allowed by the LTE specifications.

Furthermore, control apparatus embodying the present invention can learn from past events how best to set the scoring strategy in certain scenarios.

Reference will now be made, by way of example, to the accompanying drawings, in which:

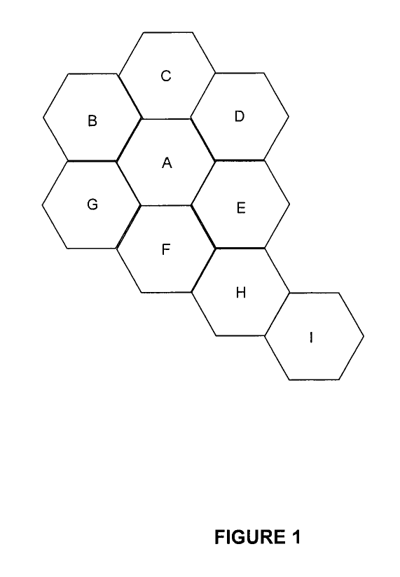

FIG. 1 illustrates part of a cellular wireless network;

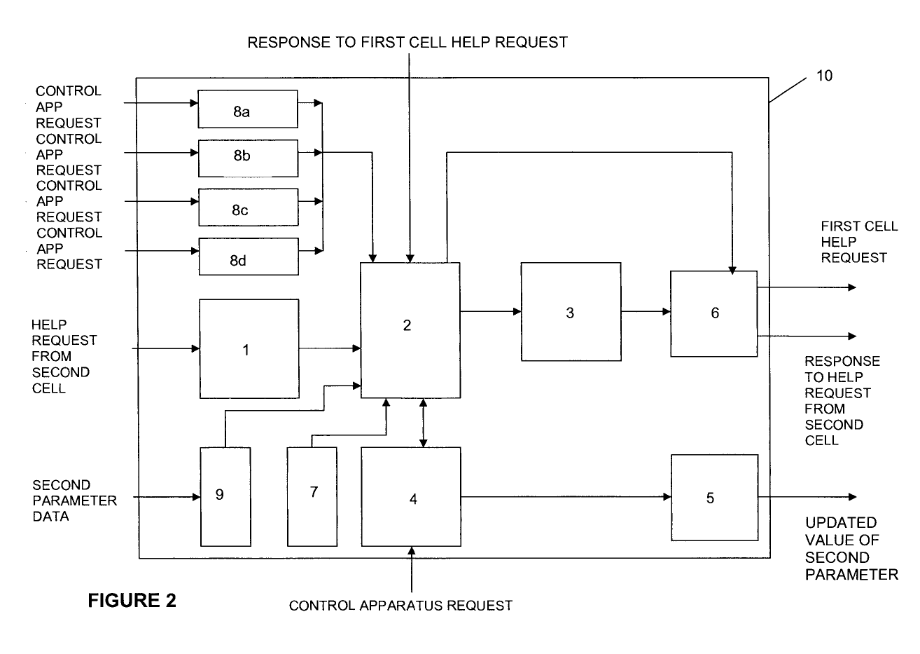

FIG. 2 shows a block diagram representing apparatus embodying the third aspect of the present invention;

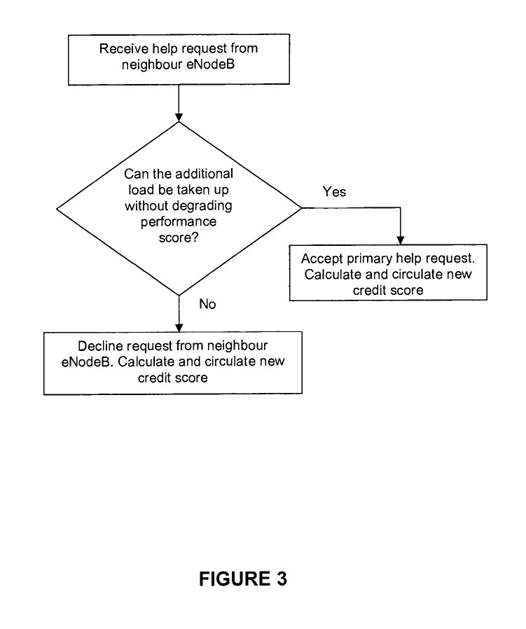

FIG. 3 illustrates a first method embodying the first aspect of the present invention;

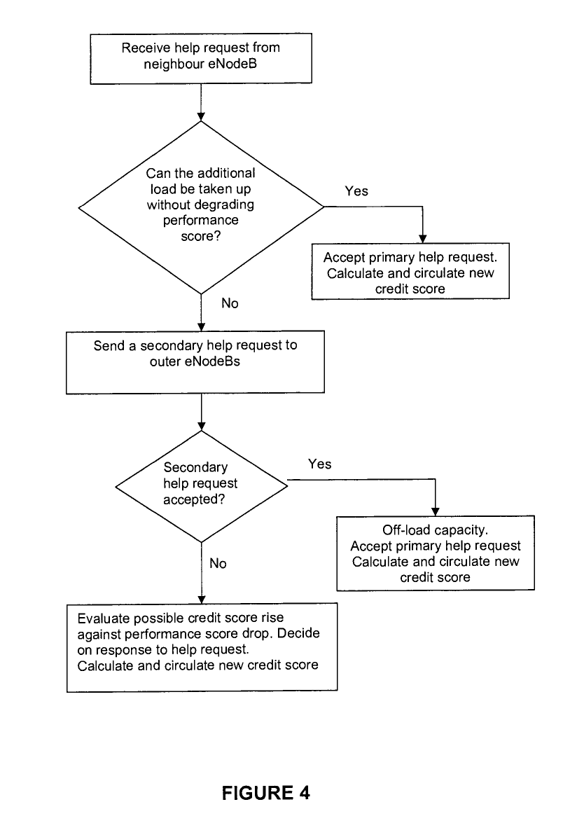

FIG. 4 illustrates a second method embodying the first aspect of the present invention;

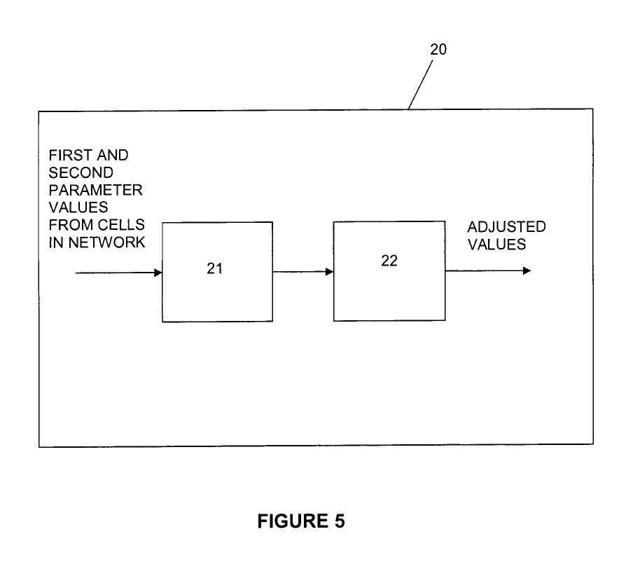

FIG. 5 shows a block diagram representing apparatus embodying the fifth aspect of the present invention;

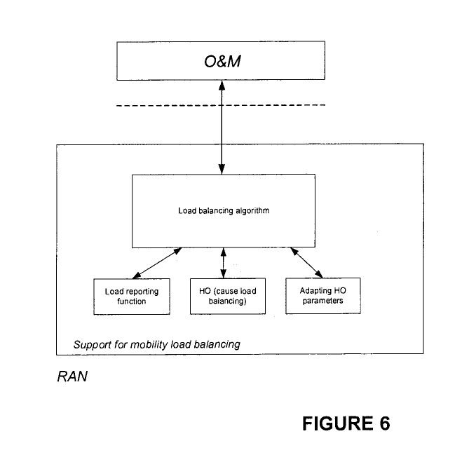

FIG. 6 illustrates architecture agreed in RAN3 as the basis for load balancing; and

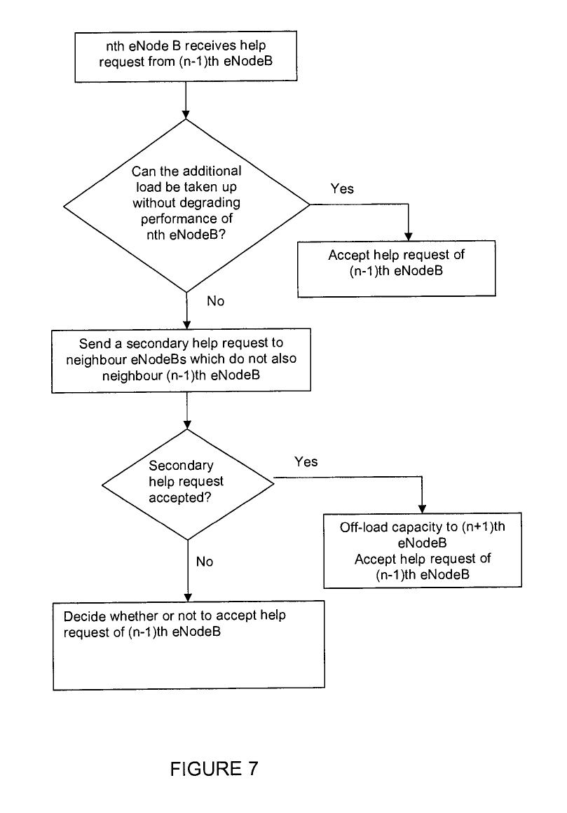

FIG. 7 illustrates a method embodying the second aspect of the present invention.

Methods and apparatus embodying the present invention concentrate on active users at the cell edge, who are linked to a single cell (serving eNodeB) but are capable of linking up with other cells (eNodeBs) in the network. These other cells (eNodeBs) are in the neighbour lists of the active users. FIG. 1 illustrates part of a cellular wireless network having a cell A, neighbouring cells B to G, another cell H which neighbours cells E and F, and a further cell I which neighbours cell H.

In an embodiment of one aspect of the present invention, a first parameter of a cell in the network is indicative of the operational performance of the cell and has an optimum value and a second parameter of the cell is indicative of the degree of acceptance by the cell of user transfers to the cell relative to the degree of requests by the cell to transfer users from the cell and has an optimum value. As shown in FIG. 2, each cell is provided with apparatus 10 comprising request receiving means 1 configured to receive, from another cell of the cellular wireless network which neighbours the first cell, a request to provide service for specified users in the second cell. The apparatus 10 also comprises determining means 2 configured to determine whether to provide service for the specified users of the second cell. The determining means 2 are connected to first parameter calculating means 7 and are operable to evaluate whether, on the basis of the cell's current load, a value of the first parameter of the first cell will be adversely affected if the request of the second cell is accepted and users are transferred from the second cell to the first cell. In order to evaluate whether the value of the first parameter will be adversely affected, the determining means 2 are preferably operable to calculate the change in the value of the first parameter which would be caused by accepting the request of the second cell, compare the changed value with a preselected value for the first parameter, and determine that the value of the first parameter will be adversely affected if the changed value is less than the preselected value, if the optimum value for the first parameter is higher than the preselected value, or if the changed value is more than the preselected value, if the optimum value for the first parameter is lower than the preselected value. Response means 3 are provided for accepting or declining the request of the second cell in accordance with the result of the determining means 2 via transmitting means 6. Updating means 4 of the apparatus 10 are configured to update the value of the second parameter to reflect the result of the determining means 2. The updating means 4 are configured to change the manner in which the value of the second parameter is updated for a particular result in accordance with a request issued by the control apparatus 20, as will be described in more detail later. Advising means 5 of the apparatus 10 are configured to advise cells neighbouring the first cell and a control means 20 (see FIG. 5) of the network, common to a plurality of cells in the network including the first cell, of the updated value of the second parameter.

Thus, using the cells A and F as examples, the cell F is operable to determine, in response to the cell F receiving a request to provide service for specified users in the neighbouring cell A, whether to provide service for the specified users of cell A by evaluating whether, on the basis of the cell's current load, a value of the first parameter will be adversely affected if the request of cell A is accepted and users are transferred from cell A to cell F. Cell F accepts or declines the request of cell A in accordance with the result of the determination, updates the value of the second parameter to reflect the result of the determination, and advises cells neighbouring cell F and a control means 20 of the network, common to a plurality of cells in the network including the first cell, of the updated value of the second parameter.

A schematic flow chart is shown in FIG. 3 to illustrate steps according to an algorithm embodying the present invention. This embodiment of the present invention is based on eNodeBs responding to load balancing requests by optimizing two scores, a performance score (first parameter value) and a credit score (second parameter value).

The performance score may be based on how well the eNodeB is achieving the KPIs (Key Performance Indicators) in the cell and is visible only to the relevant eNodeB and OAM (control apparatus). The performance score may be updated by the eNodeB by looking at the key performance indicators (KPI) within the cell. These KPI include network admission rates, call drop rates, latency etc.

The credit score of an eNodeB goes up if the eNodeB decides to accept a load balancing request (a request to offload some of the active cell edge users from a serving eNodeB), hereafter sometimes referred to as a “help” request, and goes down if the eNodeB decides to decline a load balancing request. The credit score of an eNodeB is visible to its neighbouring eNodeBs and the OAM.

Although higher credit/performance scores are described here as being the goal of the eNodeBs, alterative scoring systems, for example such as one in which the goal of the eNodeBs is to achieve lower credit/performance scores, are possible.

An eNodeB can also conditionally accept a load balancing request by sending a secondary request to offload some of its users to one or more neighbouring cells. If it is determined that the value of the said first parameter will be adversely affected if the request of the second cell is accepted, a secondary request is sent to cells neighbouring the first cell, which are not neighbours of the second cell, to provide service for specified users of the first cell, and, if the secondary request of the first cell is accepted, the request of the second cell is accepted and the specified users are transferred from the first cell and the second cell, the value of the second parameter of each cell which accepted the secondary request is updated to reflect the acceptance, and cells neighbouring each cell which accepted the secondary request and the control means are advised of that updated value. For example, if cell F determines that it cannot accept a request from cell A, it issues a secondary request to cells which do not neighbour cell A, such as cell H. If cell H, for example, accepts the secondary request from cell F, cell F accepts the secondary request from cell A, specified users are transferred from cell F to cell H and from cell A to cell F, the values of the second parameter of cells F and H which accepted the secondary requests are updated to reflect the acceptance, and cells neighbouring cells F and H and the control means are advised of that updated value.

If the request of the first cell is not accepted, whether to accept the request of the second cell is determined by calculating what changes in the values of the said first and second parameters would be caused by accepting the request of the second cell, and the decision to accept or decline the request of the second cell is made on the basis of a comparison using the changed values for the first and second parameters. A second schematic flow chart is shown in FIG. 4 to illustrate steps according to this embodiment of the present invention. By way of example, in order to make the decision to accept or decline the request of the second cell on the basis of the comparison, the proximity of the changed value of the second parameter to a preselected value for the second parameter and the proximity of the changed value of the first parameter to the preselected value for the first parameter may be determined.

The load balancing request (primary load balancing request) issued by the second cell can be propagated further outwards through the network, according to the load on the cells. For example, the request can be propagated through a chain of up to N cells, where the maximum number N of cells in the chain may be determined by the system settings. In particular, a further secondary request may be issued by each of n further cells in the network, a further secondary request issued by the nth cell being a request for another cell to provide service for specified users of the nth cell, where 1≦n≦N, N is a preset maximum number of cells which are permitted to issue such a further secondary request, and the nth cell is neighboured by the (n−1)th cell (except where n is 1 where it is neighboured by the first cell). A further secondary request is issued by the nth cell when, on the basis of the current load of the nth cell, the value of the first parameter of the nth cell will be adversely affected by accepting a further secondary request from the (n−1)th cell (except when n is 1 in which case a further secondary request is issued by the nth cell when, on the basis of the current load of the nth cell, the value of the first parameter of the nth cell will be adversely affected by accepting the secondary request of the first cell). If the further secondary request of the nth cell is accepted, the received request of the (n−1)th cell is accepted and the specified users are transferred from the (n−1)th cell and the nth cell (except where n is 1 in which case the received request of the first cell is accepted and the specified users are transferred from the first cell and the nth cell), the value of the second parameter of the (n+1)th cell, which accepted the secondary request, is updated to reflect the acceptance, and cells neighbouring the (n+1)th cell and the control means are advised of that updated second parameter value. Thus, each cell receiving a help request carries out the steps shown in FIG. 4. For example, a secondary request received by cell H may prompt the issuance by cell H of a further secondary request to neighbouring cell I, and so on.

As explained in more detail below, the OAM can influence the behaviour of eNodeBs by changing the scoring strategies of the eNodeBs concerned. Thus, an eNodeB can make an autonomous decision to accept, conditionally accept or reject a load balancing request, while the OAM observes the variations of the two scores of the eNodeBs and influences the behaviour of the eNodeBs only when required.

The amount of change in the value of the second parameter of the first cell made when a request from a second cell is accepted may be dependent upon the value of the second parameter of the second cell before acceptance of the request. In this case the apparatus 10 may comprise storage means 9 for storing the current values of the second parameter of the other cells in the network. Preferably the configuration is such that if an eNodeB assists a neighbouring eNodeB with a higher credit score, the credit score of the eNodeB providing assistance increases by a higher amount than it would if the credit score of the eNodeB being assisted were lower. Conversely, the configuration is preferably such that if an eNodeB assists a neighbouring eNodeB with a lower credit score, the credit score of the eNodeB providing assistance increases by a lower amount than it would if the credit score of the eNodeB being assisted were higher. Thus, when determining whether to provide service for the specified users of the second cell, account may be taken of the current value of the second parameter of the second cell and/or the first cell. Accordingly, an eNodeB is more likely to assist eNodeBs with higher credit scores and to try to maintain its credit score at a higher level, so when it sends out a help request it is more likely to get assistance.

The value of the second parameter of a cell in the network may be downgraded when it issues a request for another cell to provide service for specified users in the cell, except where this request is in response to a request of a further cell to provide service for users in the further cell. In particular, in order to deter the eNodeBs from sending out frequent help requests as a first course of action, sending out a help request preferably causes the credit score of the sending eNodeB to be decreased by a certain margin. An exception to this is when an eNodeB conditionally accepts a help request and sends a request to its neighbouring eNodeBs to offload some of its own capacity, so it can accommodate the original help request without degrading its service. This kind of behaviour helps to ease service demands in a capacity hotspot, by propagating help requests to cells outwards from the hotspot.

FIG. 5 illustrates control apparatus 20 embodying another aspect of the present invention for use in a cellular wireless network, such as the one described with reference to FIG. 1. The control apparatus 20 comprises monitoring means 21 configured to monitor the values of the first and second parameters of cells in the cellular wireless network. In this case, the updating means 4 of the apparatus 10 are configured to update the value of the first parameter if the request of the second cell is accepted, and the advising means 5 of the apparatus 10 are also configured to advise cells neighbouring the first cell and the control means of the updated value of the first parameter. The control apparatus 20 also comprises adjustment means 22 configured to adjust the amount of change in the value of the second parameter, which is to be imposed upon updating of the second parameter, of a designated one of the cells on the basis of one or more of the monitored values in accordance with an objective to be achieved. For example, in some cases when the eNodeB opts to assist a neighbour eNodeB, it may have to degrade the service quality to its users, which will degrade its performance score. The control apparatus (OAM) looks at both the performance score and credit score of an eNodeB and acts to rectify certain tendencies. If a certain eNodeB maintains a high credit score and a low performance score, it indicates that this eNodeB is helping others at the cost of its own performance. The OAM can then change the scoring strategy for this eNodeB, for example by instructing that only a minimal change or no change in credit score is made for assisting others or seeking assistance.

It may also be desirable for the adjustment means 22 to be configured to adjust the optimum value for the first parameter and/or the optimum value for the second parameter and/or the preselected value for the first parameter and/or the preselected value for the second parameter of a designated one of the cells in accordance with an objective to be achieved. In this case the apparatus 10 preferably comprises first and second preselected value changing means 8a, 8b, configured to change the preselected value for the first and second parameters in response to respective first parameter preselected value and second parameter preselected value adjustment requests from the control means 20, and first and second optimum value changing means 8c, 8d configured to change the optimum value for the first and second parameters in response to respective first parameter optimum value and second parameter optimum value adjustment requests from the control means 20. Preferably, the configuration of the adjustment means 22 is such that past events are taken into account when an adjustment is made.

By observing the behaviour of the eNodeBs through the changes in credit score and performance score updates and changing the scoring strategies where desirable, the OAM can adapt the behaviour of eNodeBs to suit dynamic traffic demands. For example, if a certain region (for example the city centre) experiences high traffic demand at certain times (for example during the lunch hour) the OAM can influence the neighbour eNodeBs to assist the eNodeB in this region more than usual, using its experience of similar or related past events to determine how best to set the scoring strategies to influence the eNodeB behaviour in the desired manner.

It should be mentioned that in November 2009, as part of release 9 features, LTE RAN3 has agreed a new cause value ‘load balancing’ as a reason to initiate handover communication between two eNodeB's. Hence, an algorithm embodying the present invention is feasible within the LTE (Advanced) context. The architecture shown in FIG. 6 has been agreed in LTE RAN3 as the basis for load balancing.

The current LTE standard specifies issuing user handover requests based on the current load of a single tier of neighbour eNodeBs. According to another aspect of the present invention, a load balancing method is envisaged in which secondary requests based only on the performance of the cells, as indicated by the current load, are made by up to N cells in a chain, where the maximum number N of cells in the chain may be determined by the system settings. In particular, an embodiment of the present invention provides a distributed load balancing method for use in cells of a cellular wireless network, in which method a first secondary request for another cell to provide service for specified users of a first cell is issued when the first cell, which has received a primary request issued by a second cell of the network for another cell in the network to provide service for specified users of the second cell, is unable, on the basis of its current load, to accept the primary request without adversely affecting its operational performance, wherein a further secondary request is issued by each of n further cells in the network, a further secondary request issued by the nth cell being a request for another cell to provide service for specified users of the nth cell, where 1≦n≦N, N is a preset maximum number of cells which are permitted to issue such a further secondary request, and the nth cell is neighboured by the (n−1)th cell (except where n is 1 where it is neighboured by the first cell). A further secondary request is issued by the nth cell when the operational performance of the nth cell will be adversely affected by accepting a further secondary request from the (n−1)th cell (except when n is 1 in which case a further secondary request is issued by the nth cell when the operational performance of the nth cell will be adversely affected by accepting the secondary request of the first cell). If the further secondary request of the nth cell is accepted, the received request of the (n−1)th cell is accepted and the specified users are transferred from the (n−1)th cell and the nth cell (except where n is 1 in which case the received request of the first cell is accepted and the specified users are transferred from the first cell and the nth cell). A schematic flow chart is shown in FIG. 7 to illustrate steps according to this embodiment of the present invention. For example, cell F may be prompted to issue a secondary request in order to accept a request received from cell A, cell H may be prompted to issue a further secondary request in order to accept a request received from cell F, cell I may be prompted to issue a further secondary request in order to accept a request received from cell H, and so on down a chain of cells, up to the maximum number allowable.

The method described above may be modified such that whether or not the operational performance of the first cell is deemed to be adversely affected by a decision to accept the secondary request of the second cell is determined by considering the affect of that decision on a first parameter of the first cell, which first parameter is indicative of the operational performance of the first cell and has an optimum value. As mentioned previously, the first parameter may be a performance score based on how well the eNodeB is achieving the KPIs (Key Performance Indicators) in the cell and may be visible only to the relevant eNodeB and OAM (control apparatus). The performance score may be updated by the eNodeB by looking at the key performance indicators (KPI) within the cell. These KPI include network admission rates, call drop rates, latency etc. The value of the first parameter of the first cell may be updated when a request to provide service for specified users of the second cell has been accepted and control means of the network, common to a plurality of cells in the network including the first cell, may be advised of that updated value of the first parameter.

The method may be further modified such that the value of a second parameter of the first cell, which is indicative of the degree of acceptance by the first cell of user transfers to the cell relative to the degree of requests by the cell to transfer users from the cell and has an optimum value, is also updated on the basis of whether or not the request of the second cell has been accepted and cells neighbouring the first cell and the control means of the network are advised of the updated value of the second parameter. As mentioned above, the second parameter of an eNodeB may be a credit score which goes up if the eNodeB decides to accept a load balancing request, and goes down if the eNodeB decides to decline a load balancing request. The credit score of an eNodeB is visible to its neighbouring eNodeBs and the OAM.

As mentioned previously, although higher credit/performance scores are described here as being the goal of the eNodeBs, alterative scoring systems, for example such as one in which the goal of the eNodeBs is to achieve lower credit/performance scores, are possible.

Various aspects of the present invention have been described with reference to networks in accordance with 3GPP LTE-A, but embodiments of the present invention may be applied to arrangements other than those described here.

In addition, although described separately, each of the different aspects of the invention may be combined with any other aspect, as appropriate.

Embodiments of the present invention may be implemented in hardware, or as software modules running on one or more processors, or on a combination thereof. That is, those skilled in the art will appreciate that a microprocessor or digital signal processor (DSP) may be used in practice to implement some or all of the functionality described above.

The invention may also be embodied as one or more device or apparatus programs (e.g. computer programs and computer program products) for carrying out part or all of the methods described herein. Such programs embodying the present invention may be stored on computer-readable media, or could, for example, be in the form of one or more signals. Such signals may be data signals downloadable from an Internet website, or provided on a carrier signal, or in any other form.

1. A distributed load balancing method for use in a cell of a cellular wireless network, in which a first parameter of each cell participating in the method is indicative of the operational performance of the cell and has an optimum value and in which a second parameter of each cell participating in the method is indicative of the degree of acceptance by the cell of user transfers to the cell relative to the degree of requests by the cell to transfer users from the cell and has an optimum value, which method comprises a first cell carrying out the steps of:
determining, in response to the first cell receiving a request to provide service for specified users in a second cell of the cellular wireless network which neighbours the first cell, whether to provide service for the specified users of the second cell by evaluating whether, on the basis of its current load, a value of the first parameter will be adversely affected if the request of the second cell is accepted and users are transferred from the second cell to the first cell;
accepting or declining the request of the second cell in accordance with the result of the determining step;
updating the value of the second parameter to reflect the result of the determining step; and
advising cells neighbouring the first cell and a control means of the network, common to a plurality of cells in the network including the first cell, of the updated value of the second parameter.

2. A method as claimed in claim 1, wherein, if it is determined that the value of the said first parameter will be adversely affected, a secondary request is sent to cells neighbouring the first cell, which are not neighbours of the second cell, to provide service for specified users of the first cell, and, if the secondary request of the first cell is accepted, the request of the second cell is accepted, the specified users are transferred from the first cell and the second cell, the value of the second parameter of each cell which accepted the secondary request is updated to reflect the acceptance, and cells neighbouring each cell which accepted the secondary request and the control means are advised of that updated value.

3. A method as claimed in claim 2, wherein a further secondary request is issued by each of n further cells in the network, a further secondary request issued by the nth cell being a request for another cell to provide service for specified users of the nth cell, where 1≦n≦N, N is a preset maximum number of cells which are permitted to issue such a further secondary request, and the nth cell is neighboured by the (n−1)th cell, except where n is 1 where it is neighboured by the first cell,
a further secondary request being issued by the nth cell when, on the basis of the current load of the nth cell, the value of the first parameter of the nth cell will be adversely affected by accepting a further secondary request from the (n−1)th cell, except when n is 1 in which case a further secondary request is issued by the nth cell when, on the basis of the current load of the nth cell, the value of the first parameter of the nth cell will be adversely affected by accepting the secondary request of the first cell, wherein, if the further secondary request of the nth cell is accepted:
the received request of the (n−1)th cell is accepted and the specified users are transferred from the (n−1)th cell and the nth cell, except where n is 1 in which case the received request of the first cell is accepted and the specified users are transferred from the first cell and the nth cell;
the value of the second parameter of the (n+1)th cell, which accepted the secondary request, is updated to reflect the acceptance; and
cells neighbouring the (n+1)th cell and the control means are advised of that updated second parameter value.

4. A method as claimed in claim 1, further comprising updating the value of the first parameter of a cell which accepts a request to provide service for specified users of another cell and advising the control means of that updated value of the first parameter.

5. A distributed load balancing method for use in cells of a cellular wireless network in which method a first secondary request for another cell to provide service for specified users of a first cell is issued when the first cell, which has received a primary request issued by a second cell of the network for another cell in the network to provide service for specified users of the second cell, is unable, on the basis of its current load, to accept the primary request without adversely affecting its operational performance,
wherein a further secondary request is issued by each of n further cells in the network, a further secondary request issued by the nth cell being a request for another cell to provide service for specified users of the nth cell, where 1≦n≦N, N is a preset maximum number of cells which are permitted to issue such a further secondary request, and the nth cell is neighboured by the (n−1)th cell, except where n is 1 where it is neighboured by the first cell,
a further secondary request being issued by the nth cell when the operational performance of the nth cell will be adversely affected by accepting a further secondary request from the (n−1)th cell, except when n is 1 in which case a further secondary request is issued by the nth cell when the operational performance of the nth cell will be adversely affected by accepting the secondary request of the first cell, and
if the further secondary request of the nth cell is accepted, the received request of the (n−1)th cell is accepted and the specified users are transferred from the (n−1)th cell and the nth cell, except where n is 1 in which case the received request of the first cell is accepted and the specified users are transferred from the first cell and the nth cell.

6. A method as claimed in claim 5, wherein, for the first cell, whether or not the operational performance of the first cell is deemed to be adversely affected by a decision to accept the secondary request of the second cell is determined by considering the affect of that decision on a first parameter of the first cell, which first parameter is indicative of the operational performance of the first cell and has an optimum value.

7. A method as claimed in claim 6, further comprising updating the value of the first parameter of the first cell when a request to provide service for specified users of the second cell has been accepted and advising control means of the network, common to a plurality of cells in the network including the first cell, of that updated value of the first parameter.

8. A method as claimed in claim 6, wherein the value of a second parameter of the first cell, which is indicative of the degree of acceptance by the first cell of user transfers to the cell relative to the degree of requests by the cell to transfer users from the cell and has an optimum value, is updated on the basis of whether or not the request of the second cell has been accepted and cells neighbouring the first cell and the control means of the network are advised of the updated value of the second parameter.

9. A method as claimed in claim 1, wherein, if the secondary request of a cell is not accepted, whether to accept the request received by that cell is determined by calculating what changes in the values of the said first and second parameters of that cell would be caused by accepting the received request, and the decision to accept or decline the received request is made on the basis of a comparison using the changed values for the first and second parameters of that cell.

10. A method as claimed in claim 9, wherein, in order to make the decision to accept or decline the received request on the basis of the comparison, the proximity of the changed value of the second parameter to a preselected value for the second parameter and the proximity of the changed value of the first parameter to a preselected value for the first parameter are determined.

11. A method as claimed in claim 10, further comprising changing the preselected value for the second parameter in response to a second parameter preselected value adjustment request from the control means.

12. A method as claimed in claim 1, further comprising changing the optimum value for the second parameter in response to a second parameter optimum value adjustment request from the control means.

13. A method as claimed in claim 1, wherein, when determining whether to provide service for the specified users of the cell which issued the request, account is taken of the current value of the second parameter of that cell.

14. A method as claimed in claim 1, wherein, when determining whether to provide service for the specified users of the cell which issued the request, account is taken of the current value of the second parameter of the cell receiving the request.

15. A method as claimed in claim 1, wherein the amount of change in the value of the second parameter made when a request is accepted by a cell is dependent upon the value of the second parameter of the cell which made the request before acceptance of the request.

16. A method as claimed in claim 1, wherein the value of the second parameter of a cell in the network is downgraded when it issues a request for another cell to provide service for specified users in the cell, except where this request is in response to a request of a further cell to provide service for users in the said further cell.

17. A method as claimed in claim 1, further comprising changing the manner in which the value of the second parameter is updated for a particular result in accordance with a request issued by the control apparatus.

18. A method as claimed in claim 1, wherein, in order to evaluate whether the value of the first parameter will be adversely affected, the change in the value of the first parameter which would be caused by accepting the received request is calculated, the changed value is compared with a preselected value for the first parameter, and it is determined that the value of the first parameter will be adversely affected if the changed value is less than the preselected value, when the optimum value for the first parameter is higher than the preselected value, or if the changed value is more than the preselected value, when the optimum value for the first parameter is lower than the preselected value.

19. A method as claimed in claim 1, further comprising changing the optimum value for the first parameter in response to an first parameter optimum value adjustment request from the control means.

20. A method as claimed in claim 1, further comprising changing the preselected value for the first parameter in response to a first parameter preselected value adjustment request from the control means.

21. Apparatus for use in a first cell of a cellular wireless network, in which network a first parameter of a cell is indicative of the operational performance of the cell and has an optimum value and in which network a second parameter of a cell is indicative of the degree of acceptance by the cell of user transfers to the cell relative to the degree of requests by the cell to transfer users from the cell and has an optimum value, which apparatus comprises:
request receiving means configured to receive, from a second cell of the cellular wireless network which neighbours the first cell, a request to provide service for specified users in the second cell;
determining means configured to determine whether to provide service for the specified users of the second cell, which determining means are operable to evaluate whether, on the basis of its current load, a value of the first parameter will be adversely affected if the request of the second cell is accepted and users are transferred from the second cell to the first cell;
response means configured to accept or decline the request of the second cell in accordance with the result of the determining means;
updating means configured to update the value of the second parameter to reflect the result of the determining means; and
advising means configured to advise cells neighbouring the first cell and a control means of the network, common to a plurality of cells in the network including the first cell, of the updated value of the second parameter.

22. Apparatus as claimed in claim 21, wherein, if the determining means determine that the value of the said first parameter will be adversely affected, the determining means are operable to initiate the transmittal to cells neighbouring the first cell, which are not neighbours of the second cell, of a secondary request to provide service for specified users of the first cell, to agree to the request of the second cell if the secondary request of the first cell is accepted and the specified users are transferred from the first cell, to update the value of the second parameter of each cell which accepted the secondary request to reflect the acceptance, and to advise cells neighbouring each cell which accepted the secondary request and the control means of that updated value.

23. Apparatus as claimed in claim 21, wherein the updating means are configured to update the value of the first parameter of a cell which accepts a request to provide service for specified users of another cell and the advising means are configured to advise the control means of that updated value of the first parameter.

24. Apparatus as claimed in claim 21, wherein, if the secondary request of a cell is not accepted, the determining means are operable to determine whether to accept the request received by that cell by calculating what changes in the values of the said first and second parameters would be caused by accepting the received request, and making the decision to accept or decline the received request on the basis of a comparison using the changed values for the first and second parameters.

25. Apparatus as claimed in claim 24, wherein, in order to make the decision to accept or decline the received request on the basis of the comparison, the determining means are operable to determine the proximity of the changed value of the second parameter to a preselected value for the second parameter and to determine the proximity of the changed value of the first parameter to a preselected value for the first parameter.

26. Apparatus as claimed in claim 25, further comprising preselected value changing means configured to change the preselected value for the second parameter in response to a second parameter preselected value adjustment request from the control means.

27. Apparatus as claimed in claim 21, further comprising optimum value changing means configured to change the optimum value for the second parameter in response to a second parameter optimum value adjustment request from the control means.

28. Apparatus as claimed in claim 21, wherein, when determining whether to provide service for the specified users of the cell which issued the secondary request, the determining means are operable to take account of the current value of the second parameter of that cell.

29. Apparatus as claimed in claim 21, wherein, when determining whether to provide service for the specified users of the cell which issued the secondary request, the determining means are operable to take account of the current value of the second parameter of the cell receiving the request.

30. Apparatus as claimed in claim 21, wherein the updating means are configured to change the manner in which the value of the second parameter is updated for a particular result in accordance with a request issued by the control apparatus.

31. Apparatus as claimed in claim 21, wherein, in order to evaluate whether the value of the first parameter will be adversely affected, the determining means are operable to calculate the change in the value of the first parameter which would be caused by accepting the received request, compare the changed value with a preselected value for the first parameter, and determine that the value of the first parameter will be adversely affected if the changed value is less than the preselected value, if the optimum value for the first parameter is higher than the preselected value, or if the changed value is more than the preselected value, if the optimum value for the first parameter is lower than the preselected value.

32. Apparatus as claimed in claim 31, further comprising preselected value changing means configured to change the preselected value for the first parameter in response to a first parameter preselected value adjustment request from the control means.

33. Apparatus as claimed in claim 21, further comprising optimum value changing means configured to change the optimum value for the first parameter in response to an first parameter optimum value adjustment request from the control means.

34. A method of controlling apparatus used in a cellular wireless network, in which network a first parameter of a cell is indicative of the operational performance of the cell and has an optimum value and in which network a second parameter of a cell is indicative of the degree of acceptance by the cell of user transfers to the cell relative to the degree of requests by the cell to transfer users from the cell and has an optimum value, which method comprises:
monitoring the values of the first and second parameters of cells in the cellular wireless network; and
adjusting the amount of change in the value of the second parameter, which is to be imposed upon updating of the second parameter, of a designated one of the cells on the basis of one or more of the monitored values in accordance with an objective to be achieved.

35. A method as claimed in claim 34, further comprising adjusting the optimum value for the first parameter and/or the optimum value for the second parameter of a designated one of the cells in accordance with an objective to be achieved.

36. A method as claimed in claim 34, further comprising adjusting a preselected value for the first parameter and/or a preselected value for the second parameter of a designated one of the cells in accordance with an objective to be achieved, which preselected values are used by the cell in determining whether to accept a request to transfer users to the cell.

37. A method as claimed in claim 34, wherein similar or related past events are taken into account when an adjustment is made.

38. Control apparatus for use in a cellular wireless network, in which network a first parameter of a cell is indicative of the operational performance of the cell and has an optimum value and in which network a second parameter of a cell is indicative of the degree of acceptance by the cell of user transfers to the cell relative to the degree of requests by the cell to transfer users from the cell and has an optimum value, which apparatus comprises:
monitoring means configured to monitor the values of the first and second parameters of cells in the cellular wireless network; and
adjustment means configured to adjust the amount of change in the value of the second parameter, which is to be imposed upon updating of the second parameter, of a designated one of the cells on the basis of one or more of the monitored values in accordance with an objective to be achieved.

39. Control apparatus as claimed in claim 38, wherein the adjustment means are also configured to adjust the optimum value for the first parameter and/or the optimum value for the second parameter of a designated one of the cells in accordance with an objective to be achieved.

40. Control apparatus as claimed in claim 38, wherein the adjustment means are also configured to adjust a preselected value for the first parameter and/or a preselected value for the second parameter of a designated one of the cells in accordance with an objective to be achieved, which preselected values are used by the cell in determining whether to accept a request to transfer users to the cell.

41. Control apparatus as claimed in claim 38, wherein the configuration of the adjustment means is such that similar or related past events are taken into account when an adjustment is made.

42. A cellular wireless network comprising a plurality of cells which neighbour one another, in which cells a first parameter of a cell is indicative of the operational performance of the cell and has an optimum value and in which cells a second parameter of a cell is indicative of the degree of acceptance by the cell of user transfers to the cell relative to the degree of requests by the cell to transfer users from the cell and has an optimum value, wherein each of the neighbouring cells is provided with apparatus as claimed in claims 21.

43. A cellular wireless network as claimed in claim 42, the network being configured such that each of n cells in the network is configured to issue a further secondary request, a further secondary request issued by the nth cell being a request for another cell to provide service for specified users of the nth cell, where 1≦n≦N, N is a preset maximum number of cells which are permitted to issue such a further secondary request, and the nth cell is neighboured by the (n−1)th cell, except where n is 1 where it is neighboured by the first cell,
the nth cell being operable to issue a further secondary request when, on the basis of the current load of the nth cell, the value of the first parameter of the nth cell will be adversely affected by accepting a further secondary request from the (n−1)th cell, except when n is 1 in which case the nth cell is operable to issue a further secondary request when, on the basis of the current load of the nth cell, the value of the first parameter of the nth cell will be adversely affected by accepting the secondary request of the first cell,
wherein, if the further secondary request of the nth cell is accepted:
the nth cell is operable to accept the received request of the (n−1)th cell, to receive the specified users from the (n−1)th cell and to transfer its specified users to an (n+1)th cell, except where n is 1 in which case the received request of the first cell is accepted and the specified users are transferred from the first cell and the nth cell; and
the (n+1)th cell, which accepted the secondary request, is operable to update the value of its second parameter to reflect the acceptance and to advise cells neighbouring the (n+1)th cell and the control means of that updated second parameter value.

44. A cellular wireless network comprising a plurality of cells, which network is configured to respond to a first secondary request for another cell of the network to provide service for specified users of a first cell of the network, which secondary request has been issued when the first cell is unable, on the basis of its current load, to accept a primary request, issued by a second cell of the network for another cell in the network to provide service for specified users of the second cell, without adversely affecting its operational performance, by causing a chain of n further cells of the network to issue further secondary requests, a further secondary request issued by the nth cell in the chain being a request for another cell to provide service for specified users of the nth cell, where 1≦n≦N, N is a preset maximum number of cells which are permitted to issue such a further secondary request, and the nth cell is neighboured by the (n−1)th cell, except where n is 1 where it is neighboured by the first cell,
wherein each of the n cells is provided with apparatus comprising determining means configured to determine whether the cell should accept a further secondary request from the preceding cell in the chain by evaluating, on the basis of its current load, whether the operational performance of the cell will be adversely affected by accepting the further secondary request and, if so, to initiate transmittal of a further secondary request, and response means operable, if the further secondary request of the cell is accepted, to accept the further secondary request from the preceding cell in the chain and cause the specified users to be transferred from the cell and the preceding cell.

45. A cellular wireless network as claimed in claim 44, wherein the determining means of the first cell are operable to determine whether or not the operational performance of the first cell is deemed to be adversely affected by a decision to accept the secondary request of the second cell by considering the affect of that decision on a first parameter of the first cell, which first parameter is indicative of the operational performance of the first cell and has an optimum value.

46. A cellular wireless network as claimed in claim 45, further comprising first updating means for updating the value of the first parameter of the first cell when a request to provide service for specified users of the second cell has been accepted and advising means for advising control means of the network, common to a plurality of cells in the network including the first cell, of that updated value of the first parameter.

47. A cellular wireless network as claimed in claim 45, further comprising second updating means for updating the value of a second parameter of the first cell, which is indicative of the degree of acceptance by the first cell of user transfers to the cell relative to the degree of requests by the cell to transfer users from the cell and has an optimum value, on the basis of whether or not the request of the second cell has been accepted, the advising means being operable to advise cells neighbouring the first cell and the control means of the network of the updated value of the second parameter.

48. (canceled)

49. (canceled)
